(19) United States
(12) Patent Application Publication
(10) Pub. No.: US 2007/0065002 A1
(43) Pub. Date: Mar. 22, 2007

(54) Adaptive 3D image modelling system and apparatus and method therefor

(76) Inventors: Laurence Marzell, London (GB); Simon William Murad, West Chiltington (GB)

Correspondence Address: ST. ONGE STEWARD JOHNSTON & REENS, LLC, 986 BEDFORD STREET, STAMFORD, CT, 06905-5619, US

(21) Appl. No.: 11/506,982

(22) Filed: Aug. 18, 2006

Related U.S. Application Data
(63) Continuation of application No. PCT/GB05/00631, filed on Feb. 18, 2005.

(51) Int. Cl. G06K 9/00

(52) U.S. Cl. 382/154

(57) ABSTRACT

A system which resolves accuracy problems with 3D modeling techniques by using a 3D computer model that is updated using views provided by, say, a camera unit or camera system. The 2D images provided by matching the perspective view of an image within the model to that of an image of the environment. The 3D computer model can therefore be updated remotely, using 2D data.

### CROSS-REFERENCE TO RELATED APPLICATIONS

The present application is a continuation of pending International patent application PCT/GB2005/000631 filed on Feb. 18, 2005 which designates the United States and claims priority from U.S. provisional patent application No. 60/545,108 filed on Feb. 18, 2004 and No. 60/545,502 filed Feb. 19, 2004. All prior applications are herein incorporated by reference.

### FIELD OF THE INVENTION

This invention relates to an improved mechanism for modelling 3D images. The invention is applicable to, but not limited to, dynamic updating of a 3D computer model in a substantially real-time manner using 2D images.

### BACKGROUND OF THE INVENTION

In the field of this invention, computer models may be generated from survey data or data from captured images. Captured image data can be categorised into either:
(i) A 2-dimensional (2D) image, which could be a pictorial or a graphical representation of a scene; or
(ii) A 3-dimensional (3D) image, which may be a 3D model or representation of a scene that includes a third dimension.

The most common form of 2D image generation is a picture that is taken by a camera. Camera units are actively used in many environments. In some instances, where pictures are required to be taken from a number of locations, multiple camera units are used and the pictures may be viewed remotely by an Operator.

For example, in the context of 2D images provided by, say, a closed circuit television (CCTV) system, an Operator may be responsible for capturing and interpreting image data from multiple camera inputs. In this regard, the Operator may view a number of 2D images, and then control the focusing arrangement of a particular camera to obtain a higher resolution of a particular feature or aspect of the viewed 2D image. In this manner, CCTV and surveillance cameras can provide a limited monitoring of real-time scenarios or events in a 2D format.

The images/pictures can be regularly updated and viewed remotely, for example updating an image every few seconds. Furthermore, it is known that such camera systems and units may be configured to capture 360° photographic images from a single location. Clearly, a disadvantage associated with such camera images is the lack of ‘depth’ on the 2D image.

Notably, camera units and camera systems in general operate from a fixed location. Thus, a further disadvantage emanates from the ability of a user/Operator to only view a feature of an image from the perspective of a camera. Furthermore, camera units do not provide any measurement data in their own right.

A yet further disadvantage associated with systems that use CCTV and surveillance camera images is that the systems do not contain the ability to provide ‘data’ (in the normal sense of the word regarding, say binary data bits) or to make measurements.

There are many instances when a user of image data desires or needs a ‘depth’ indication associated with a particular feature of an image, in being able to fully utilise the image data. One of many examples where a 3^{rd} dimension of an image has proven critical is in the field of surveying. There are many known techniques of obtaining 3D data, for example using standard surveying techniques, such as Theodolites, electronic digital measurement techniques (EDM), etc. EDM, for example, uses a very slow laser scan that locates the top of a distal pole in 3D space in order to acquire 3D data. A further 3D data capture technique is photagrammetry, which allows a 3D representation to be created from two or more known photographs.

Thus, 3D data capture techniques, such as 3D laser systems, have been developed for, inter-alia, surveying purposes to provide depth information to an image. It is known that such 3D laser systems may incorporate a scanning feature. This has enabled the evolution from a user being able to obtain 50 3D data points per day from EDM, to 1,000,000 3D points within say six minutes using 3D laser scanning.

The most common type of laser scanner system that is currently used is an Infra-Red (IR) laser emitting system. A laser is discharged from the scanning unit, which reflects the IR signal back off the nearest solid object in its path. The time in which the laser beam takes to return to the scanner is calculated, which therefore provides a measurement of the distance and position of the point at which the laser beam was reflected, relative to the scanner. The scanner emits a number of laser pulses, approximately one million pulses every four minutes. The point at which any beam is reflected, from a solid object, is recorded in 3D space. Therefore a gradual 3D point cloud, or point model is generated as the laser scanner increases the area coverage, each point having 3D coordinates.

3D laser scanning systems were originally developed for the surveying of quarry sites and volume calculations for the amount of material removed following excavation. Subsequently, such 3D laser scanning systems have been applied to other traditional surveying projects, including urban street environments and internal building structures.

Referring now to FIG. 1, a known mechanism 100 for generating 3D computer models from such captured 3D data is illustrated. By performing a large number of surveys, say using a 3D laser scanning approach 105, 3D image data can be collated and used as a base to build subsequently accurate 3D computer models of particular environments. The 3D computer models 110 can be built by virtue of the fact that every point within the scan data has been provided with 3D coordinates. Advantageously, once a model has been developed, the model can be viewed from any perspective within the 3D coordinate system.

However, the output 125 of such 3D computer models are known to be only ‘historically’ accurate, i.e. the degree of accuracy to which a model environment relates to the real environment is dependent upon how much the real life environment has changed since the last survey was carried out. Furthermore, in order to update the computer model 130, further scans/3D surveys are required, which are notoriously slow and expensive due to the time required to obtain and process the 3D laser scan data.

Thus, there exists a need in the field of the present invention to provide a 3D data capturing and modelling system, associated apparatus, and method of generating a 3D model, wherein the above mentioned disadvantages are alleviated.

### SUMMARY OF THE INVENTION

In accordance with a first aspect of the present invention there is provided an adaptive three-dimensional (3D) image modelling system. The modeling system comprises a 3D computer modelling function having an input that receives 3D data and generates a 3D computer model from the received 3D data and a two-dimensional (2D) input providing 2D data such that the 3D computer modelling function updates the 3D model using the 2D data.

In accordance with a second aspect of the present invention there is provided a signal processing unit capable of generating and updating a three dimensional (3D) model from 3D data. The signal processing unit is characterised in that it is configured to receive two-dimensional (2D) data such that the 3D model is updated using the 2D data.

In accordance with a third aspect of the present invention there is provided a method of updating a three dimensional computer model. The method includes the steps of receiving two dimensional (2D) data, and updating the 3D computer model using the 2D data.

Thus, in summary, the aforementioned accuracy problems with known 3D modelling techniques are resolved by using a 3D computer model that is updated using views provided by, say, a camera unit or camera system. The 2D images provided by matching the perspective view of an image within the model to that of an image of the environment. The 3D computer model can therefore be updated remotely, using 2D data.

### BRIEF DESCRIPTION OF THE DRAWINGS

Exemplary embodiments of the present invention will, now be described, with reference to the accompanying drawings, in which:

FIG. 1 illustrates a known mechanism for generating 3D computer models from captured 3D data;

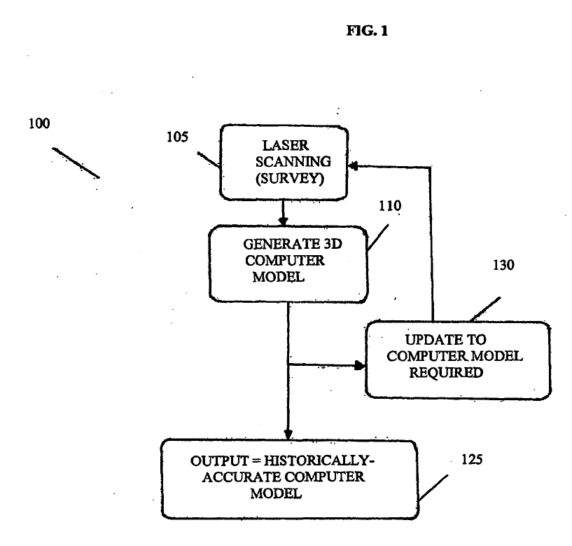

FIG. 2 illustrates a mechanism for generating 3D computer models from 2D data, in accordance with a preferred embodiment of the invention;

FIG. 3 illustrates a preferred laser scanning operation associated with the mechanism of FIG. 2, in accordance with a preferred embodiment of the invention;

FIG. 4 illustrates a simple schematic of an image in the context of a camera matching process; and

FIG. 5 shows a 3D representation of a road-scene image that can be updated using the aforementioned inventive concept.

### DETAILED DESCRIPTION OF THE INVENTION

In the context of the present invention, and the indications of the advantages of the present invention over the known art, the expression ‘image’, as used in the remaining description, encompasses any 2D view capturing a representation of a scene or event, in any format, including still and moving video images.

The preferred embodiment of the present invention proposes to use a 3D laser scanner, to capture 3D data for a particular image/scene. It is envisaged that 3D laser scanning offers the fastest and most accurate method of surveying large environments. Although the preferred embodiment of the present invention is described with reference to use with a 3D laser scanning system, it is envisaged that the inventive concepts can be equally applied with any mechanism where 3D data is provided. However, a skilled artisan will appreciate that there are significant benefits, in terms of both speed and complexity, in using the inventive concept with a 3D laser scanning system to be the initial 3D computer model.

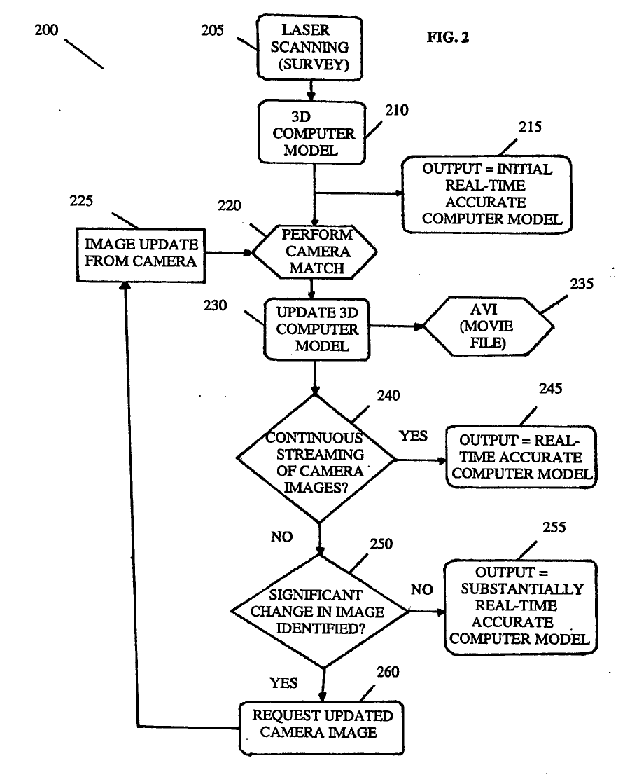

Referring now to FIG. 2, a functional block diagram/flowchart of an adaptive 3D image creation arrangement 200 is illustrated, configured to implement the inventive concept of the preferred embodiment of the present invention. The preferred embodiment of the present invention proposes to use a 3D laser scanner 205, such as a Riegl™ Z210 or a Z360, to obtain 3D co-ordinate data. Such a 3D laser scanner 205 has a range of approximately 350 metres and can record up to 6 million points in one scan. It is able to scan up to 336° in the horizontal direction and 80° in the vertical direction.

One option to implement the present invention is to use Riegl's “RiScan” software or ISite Studio 2.3 software to capture the 3D data.

It is envisaged that the inventive concept of the present invention can be applied to one or more camera units that may be fixed or moveable throughout a range of horizontal and/or vertical directions.

Notably, every captured data point in the scan comprises 3D co-ordinate data. As well as 3D coordinates, some laser scanners also have the ability to record RGB (red, green, blue) colour values as well as reflectivity values for every point in the scan. The RGB values are calculated by mapping one or more digital photographs, captured from the scanner head, onto the points. It is necessary to have sufficient lighting in order to record accurate RGB values; otherwise the points appear faded.

The reflectivity index is a measure of the reflectivity of the surface of which a point has been recorded. For example, a road traffic sign is highly reflective and would therefore have a high reflectivity index. It would appear very bright in a scan. A tarmac road has a low reflectivity index and would appear darker in a scan. Viewing a scan in reflectivity provides useful definition of a scene and allows an Operator to understand the data of an environment that may have been scanned in the dark.

Thus, in this manner and in addition to the enormous number of raw 3D data points that are extracted from the 3D laser scanning system, additional criteria can be used to provide a more accurate 3D computer model from the raw data.

The output from the 3D laser scanning system 205 is therefore 3D co-ordinate data, which is input into a 3D computer model generation function 210. There are a number of ways that the 3D computer model generation function 210 may build 3D models from scan data. In a first method, surfaces can be created using algorithms such as that provided by ISite Studio 2.3, whereby meshes are formed from 3D co-ordinate data. The surfaces can be manipulated, if required, using smoothing surfaces and filtering algorithms written into ISite Studio. Such filtering techniques are described in greater detail later.

The surfaces may then be exported, in ‘dxf’ format, into Rhinoceros 3D modelling software. A common method for modelling road surfaces is to import the mesh created in ISite Studio and create cross sections, say perpendicular to a single dimension aspect of the image such as a length of road. Cross section curves may then be smoothed and lofted together to form a smoother road surface model. This method allows the level of detail required on a road surface to be accurately controlled by the degree of smoothing.

In a second method, CAD data drawn in ISite Studio 2.3 may be exported into Rhinoceros 3D. The lines are used to create surfaces and three-dimensional objects.

In a third method, 3D co-ordinate data may be exported from ISite Studio 2.3 directly into Rhinoceros 3D in ‘dxf’ format. The 3D co-ordinate data may then be converted into a single “point cloud” object, from which the 3D models can be built. Rhinoceros 3D modelling software has many surface modelling tools, all of which may be applicable, depending on the object to be modelled.

In a fourth method, a combination of 3D co-ordinate data, CAD lines and surfaces imported from ISite Studio 2.3 may be used to model a scanned environment and built in the Rhinoceros 3D software.

Once an initial model has been built, it may be exported into 3D Studio Max (say, Release 6) where further modelling and optimization may be applied. In particular, 3D Studio Max is preferably used to produce the correct lighting and apply the textures for the scene. Textures are preferably created from digital photographs taken of the pertinent environment. The textures may be cropped and manipulated in any suitable package, such as Adobe Photoshop.

It is envisaged that the models may be animated in 3D Studio Max and then rendered to produce movie files and still images. There are various rendering tools within the software that can be used, which control the accuracy and realism of the lighting. However, the rendering tools are also constrained by the time taken to produce each rendered frame. The movie files are then composited using Combustion 2.1.1, whereby annotations and effects can be added.

The 3D models can be exported out of 3D Studio Max for real-time applications, allowing an operator to navigate around the textured scene to any location required. Two formats are currently used in this regard:
(i) The model can be exported in VRML format and viewed in a VRML viewer, e.g. Cosmo Player. The VRML format will also import any animation created in 3D Studio Max. Therefore, an operator is able to navigate to any position within the pertinent scene whilst an animated scenario is running in the background. The VRML format may be hindered by the file size restriction that forces the models and textures to be minimized and optimized to allow fluid real-time navigation.
(ii) The model can be exported into Quadrispace software. Notably, Quadrispace does not import animation information. However, Quadrispace does operate with a 3D and 2D interface so that the Operator is able to navigate around a scene in 3D space whilst a smaller window, located in say, a lower corner of the scene, shows the operator's position with the model on a 2D plan. It will then update the view in the 3D window. Even though it is possible to import reasonably large files into Quadrispace, it is still necessary to optimize the models in 3D Studio Max prior to exporting.

Thus, building 3D computer models from scan data can be performed in a number of ways. The correct method is very much dependent upon the type of model to be built and should be selected by considering, not least:
(i) The complexity of the scanned object;
(ii) The required accuracy of the 3D model; and
(iii) Any memory limitations imposed on the final model file size.

Thus, 3D modelling should only be performed by a competent and experienced 3D modeller, who has prior knowledge of modelling with scan data. For example, if a 3D real-time 3D model were to be created of a building, the 3D computer modeller would be conscious of the fact that the model would have to be of minimal size, in-order for a real-time ‘walk-through’ simulation to run smoothly.

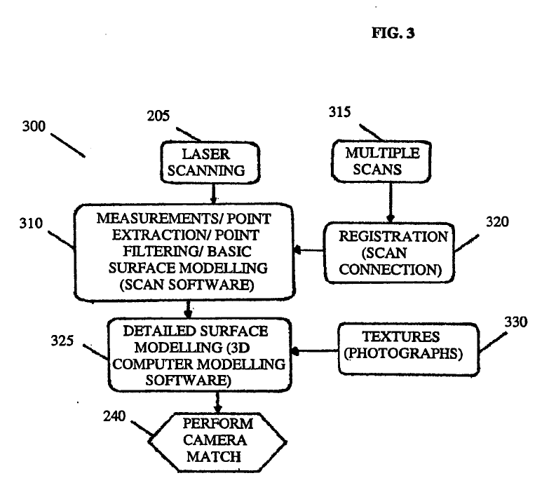

The 3D computer modelling operation 210 using the imported 3D raw data is a relatively simple task, where lines are generated to connect two or more points of raw data. A suitable 3D modelling package is the Rhinoceros™ 3D modelling software. However, a skilled artisan will appreciate that a 3D laser scanning system exports huge amounts of raw data. Most of the complexity involved in the process revolves more around the manipulation or selective usage of scan data, rather than the simple connection of data points within the 3D computer modelling operation 210. The preferred implementation of the 3D laser scanning operation is described in greater detail with respect to FIG. 3.

Advantageously, once the 3D computer model has been generated by the 3D computer modelling function/operation 210, it is possible for any Operator or user of the 3D model to view the dimensionally-accurate 3D computer model from any perspective within the 3D environment. Thus, an initial output 215 from the 3D computer model 210 can be obtained and should be (relatively) accurate at that point in time.

As indicated earlier, this model is only historically accurate, i.e. the computer model is only accurate at the time when the last laser scan was taken and until such time that the 3D environment changes. Typically, it is not practical to continuously scan the environment to update the 3D computer model. This is primarily due to the time and cost involved in making subsequent scans. For example, a 3D laser scanner with corresponding software would cost in the region of £100 k. Hence, it is impractical, in most cases, to leave a 3D laser scanner focused on a particular scene. Furthermore, as the amount of data that is used to update the model is huge, there is a commensurate cost and time implication in processing the 3D data.

The preferred embodiment of the present invention, therefore, proposes a mechanism to remove or negate the historical accuracy of the 3D computer model by regularly or continuously updating the model with pertinent information. In particular, it is proposed that a 3D computer model may be updated using 2D representations, for example obtained from one or more camera units 225 located at and/or focused on the ‘real’ scene of the model. Thus, a modelled scene may be continuously (or intermittently) updated using camera (2D image) matching techniques to result in a topographically and dimensionally accurate view (model) of a scene, i.e. updating the model of the scene whilst it is changing.

In this context, it is assumed that the 2D images generated by a camera unit may be obtained wirelessly, and by any means, say via a satellite picture of a scene. Furthermore, the camera units preferably comprise a video capture facility with a lens, whereby an image can be obtained via pan, tilt and/or zoom functions to allow an Operator to move around the viewed image.

Preferably, the one or more camera units 225 of a camera system is/are configured with up to 360° image capture, to obtain sufficient information to update the 3D computer models remotely. The updating of the 3D computer model is preferably performed by importing one or more images captured by the camera system into the background of the model.

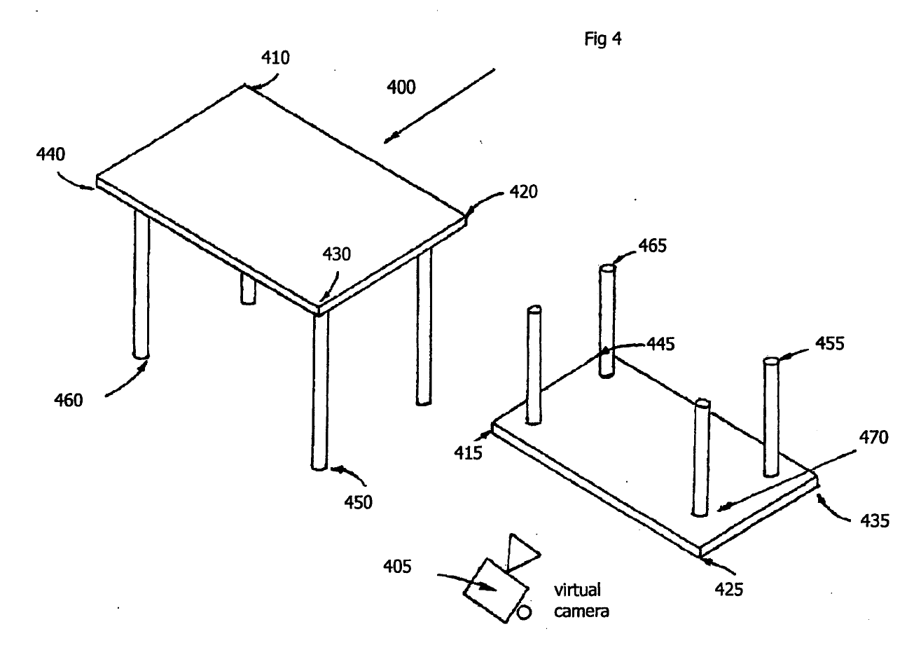

In order to determine changes to a 3D computer model based on a 2D image from a camera, the preferred embodiment of the present invention proposes to use a ‘virtual’ camera in 3D space. The virtual camera is positioned in 3D space to replicate the ‘real’ camera that has taken the 2D image. The process of identifying the location of the ‘virtual’ camera and accurately comparing a match of the 2D image with a corresponding view in 3D space is termed ‘camera matching’ 220. The process of camera matching, i.e. matching of the perspective of the photographic image to the image seen by a virtual camera, to a model in 3D space can be better appreciated with reference to FIG. 4.

It is envisaged that the camera match process may compare a number of variables, comprising, but not limited to, projection techniques for projecting 2D images, a resolution of the projected 2D image, a distance of a pertinent object from the camera taking the 2D image, a size or dimension of the object and/or a position of the object within the image as a whole. A suitable camera unit to implement the aforementioned inventive concept is the iPIX™ R2000 camera, which captures two images with 185 degree fields of view.

Referring now to FIG. 4, a perspective view 400 of a picture of a table is illustrated, together with a computer model 470 of the same table.

An accurate 3D computer model of a pertinent object or environment may be opened using the 3D modelling software package: 3D studio Max™ by Discreet™. Here, the photographic image is opened in the background of a view-port, within which the 3D model is visible. A camera match function (say camera match function 220 of FIG. 2) which is offered as a feature of this software, is then selected and the Operator is prompted to select key points on the 3D computer model that can be cross referenced to the photographic image. For example the four corners of the table 410, 420, 430 and 440 may be selected, together with, say, two of the table leg bases 450 and 460.

Once the key points are saved, the Operator must select each point individually and click on the corresponding pixel of the photograph. Finally, once all the points on the model have been cross-referenced to the photograph, the software creates a ‘virtual camera’ 405 in the 3D space model environment, which can then be positioned to display in the same perspective the same image in 3D space as the 2D photographic image viewed from the ‘real’ camera. Thus, the Operator is able to match the 3D computer model points 415, 425, 435, 445, 455 and 465 with the corresponding points 410, 420, 430, 440, 450 and 460 from the photographic image. Thereafter, the Operator is able to identify any change to the scene, and replicate this in the 3D model.

Additionally, it is envisaged that the photographic image may be continuously replaced with one or more updated photographs, preferably captured from the same camera and perspective. If something within the scene has changed, it is possible to use known dimensional data of other parts of the scene to update the computer model. The photographic image(s) may be updated manually, upon request by an Operator, or automatically if a change in the environment is detected.

In the above context, the term ‘virtual’ camera is used to describe a defined view in the computer modelling software, which is shown as a camera object within the 3D model.

Referring back to FIG. 2, and notably in accordance with the preferred embodiment of the present invention, it is proposed that the 3D computer model 210 is compared with substantially real-time data (or at least data recently) obtained using a camera system 225. The camera system 225 captures 2D images, which are then used to ascertain whether there has been any change to the viewed (and 3D computer modelled) environment. In this regard, in order to ascertain whether the 3D model is accurate, a comparison is made by the computer or the Operator between the visual data contained in the image captured by the camera unit(s) in step 225 and that contained in the 3D computer model 210. The associated 3D computer model 210 may then be modified with any updated 2D information, to provide an updated 3D computer model 230.

Thus, it is proposed that a ‘virtual camera’ is created in 3D space that allows the Operator to view the 3D model from the same perspective as the captured image(s), i.e. on a similar bearing and at a similar range to the camera unit that initially captured the image. In this manner, the provision of a ‘virtual camera’ in 3D-space within the model allows the 3D modeller to add or modify any aspect of the 3D model in order to match the photographic image(s).

For some applications of the inventive concept herein described, such as re-creation of traffic incidents, it is envisaged that a video or movie file may be generated using automatic vehicle identification (AVI) means 235.

Preferably, a High-tech system with real-time streaming of 2D data images is implemented. Thus, in this manner, the High-tech system is envisaged as being able to automatically update the computer model with continuous streaming of digital images, in step 240. Furthermore, it is envisaged that an update duration of approx. one second may be achieved. Streaming images are sent to the computer model that track, say, vehicle and human movement and update the positions of their representative objects in the model environment. Such a process effectively provides a ‘real-time’ accurate 3D computer model, as shown in step 245.

Alternatively, or in addition, it is envisaged that a Low-tech system may be provided, with an estimated 3D computer model update duration of thirty minutes. In this system, a real-time virtual reality 3D computer model is created from scan data of an environment that has one or more camera unit(s) already installed within it. Hence, assuming that an Operator is able to view the images provided by the camera unit(s), the Operator is able to realise that something has changed in the environment. The Operator is then able to send an image of the updated environment to a 3D computer modelling team. By applying the aforementioned camera matching techniques, the image(s) captured from the camera unit(s) is/are used to update the raw 3D computer model. Some dimensional information of the updated feature may be required to improve accuracy.

Alternatively, a Medium-tech system with an estimated model update duration of, say, 5-10 minutes, may be provided. Such a Medium-tech system is envisaged as being used to update environments and analyse temporary features in the environment, e.g. determining a position of an unknown truck.

Here, if continuous streaming of digital images 240 is not used, and if an object changes or is introduced into the real environment in a significant way, or that some movement has occurred in a sensitive part of the environment (e.g. an unknown vehicle has parked near a sensitive location), the alteration is preferably detected, as in step 250. The camera unit/system is preferably configured with a mechanism to transmit an alert message to the 3D computer modelling team, together with an updated image. The 3D computer model is then updated using information obtained from the image only.

Primarily, it is envisaged that a benefit of the inventive concept herein described is to re-position objects already located within a modelled scene, where the dimensions of the objects are already known. However, in many instances, it is envisaged that a model library of objects (such as vehicular objects) may be used to improve accuracy and time for interpreting new objects that have been recorded as moving into a scene.

In this manner, a vehicle model of similar dimensions to that in the image can be quickly imported into the environment model and positioned using the camera match process.

If no ‘significant’ change is identified, it can be assumed that the 3D computer model output is substantially accurate in a real-time sense, as shown in step 255.

It is envisaged that threshold values may be used to ascertain whether slight changes detected in a photographic feature's location is sufficient to justify updating of the 3D computer model. For example, when an Operator identifies a significant change to a scene, or when the system uses an automatic identification process using, say, an IR or motion detector coupled to the camera system a threshold of bit/pixel variations may be exceeding leading to, a new image being requested, as shown in step 260. Subsequently, the new image provided by the one or more camera unit(s) may be used to update the computer model, as shown in step 225.

It is envisaged that an appropriate time for requesting a new camera image is when a camera moves. Notably, movement of a camera, or indeed any different view from a camera, say, by increasing a ‘zoom’ value, requires a new camera matching operation to be performed.

Referring now to FIG. 3, a more detailed functional block diagram/flowchart 300 of the preferred 3D laser scanning system to obtain 3D data is illustrated, in accordance with the preferred embodiment of the present invention.

The system comprises a 3D laser scanning operation 305, which provides a multitude of 3D measurement points/data items. These measured data items may comprise point extraction information, point filtering information, basic surface modelling, etc., as shown in step 310.

Before any modelling is carried out it is important to filter the scan data correctly to optimise its use. This will remove any unwanted points and hopefully significantly reduce the scan file sizes, which are normally in the region of 100 MB each. This is another area where the technical expertise of a 3D modeller becomes paramount, namely the manipulation and careful reduction of raw 3D data to a manageable subset of the critical aspects of the 3D data (but at a reduced memory size). The terminology generally used for this raw data reduction process is ‘filtering’.

There are a number of useful filtering techniques that can be applied, the most pertinent of which include:
(i) ‘Edge detection’—automatically detecting hard edges in the scan data and removing points in between, for example the outline of buildings.
(ii) ‘Filter by height’—retaining the highest or lowest points in a scan, which can be useful for removing points detected from people or vehicles
(iii) ‘Minimum separation’—filtering the points so that no two points are within a specified distance of each other. This is particularly useful for reducing scan file sizes as it focuses on removing points near the scanner, where there are an abundance of points, and does not affect areas away from the scanner where the number of points is limited.

There are limited 2D and 3D modelling capabilities built into the aforementioned scanner software. However, it is possible to create lines between points that can then be exported into computer modelling software. It is also possible to create surfaces in the scanner software, which can also be exported for further use in the modelling software. These have the advantage of being highly detailed and at the same time are also reasonably intensive on file size.

Alternatively, it is possible to export point data directly into the modelling software and build lines and surfaces therefrom. This has the advantage of increased control over the complexity and accuracy of the 3D model. However, the number of points that can be imported into modelling software is generally limited to approximately 50 MB. Point extraction is the general term used for the exporting of points from the scanning software into the modelling software.

Thus, a skilled artisan appreciates that the complexity involved in the above process, and the ultimate accuracy of the computer model, is largely dependent upon the correct manipulation of the raw scan (point) data, before the data is exported to the modelling software, rather than the complexity involved in the computer modelling aspect itself. In most of the envisaged applications, it is believed that multiple scans will be performed to improve the accuracy of the 3D computer model. If time is critical and/or file size is very restricted, it is envisaged that a single scan may be performed, say for a particular area or feature of a scene.

When multiple scans are taken in step 315, typically performed from a plurality of different locations, there needs to be a mechanism for ‘linking’ the overlapping common points of the scanned data between the respective scans. This process is generally referred to as ‘registration’, as shown in step 320. Thus, a registered point cloud is generated from multiple scans, where the respective 3D data points have been orientated to a common co-ordinate system by matching together overlapping points. In this manner dimensionally-accurate 3D computer models of the environments can be created.

The 3D measurement data is then preferably input to a detailed surface modelling function 325, contained within the 3D computer modelling software. The detailed surface modelling function 325 preferably configures the surfaces of objects to receive additional data that may assist in the modelling operation, such as texture information, as shown in step 330. In this context, the 3D modeller preferably selects a method of building the surfaces of objects, walls, etc. that optimises the size of the file whilst considering the desired/required level of detail.

In this context, the surfaces of the model are ‘textured’ by mapping the images of pertinent digital photographs over the respective surface. This is primarily done to improve the realism of the model as well as providing the Operator with a better understanding and orientation of the scene. In summary, a texture is usually created from a digital photograph and comprises a suitable pattern for the area of the image, e.g. brick work, which is projected onto a surface of a computer model to make it appear more realistic.

One further mechanism for reducing file size of a 3D computer model is to use a library of basic shapes or surfaces. This enables areas of the 3D model to be represented by a lesser amount of data than that provided by raw 3D laser scan data. This function is performed by either copying some of the points into the modelling software or creating basic surfaces and shapes in the scanner software and then exporting those into the modelling software. Thus, it is envisaged that as a preferred mechanism for reducing the amount of scanned data to initially generate the model, or improve the accuracy of updates to the 3D model from 2D images, a selected object may be represented from a stored image rather than generated from a series of salient points.

In summary, according to the preferred embodiment of the invention, a mechanism is provided that allows a 3D computer model of an environment to be updated using 2D images extracted from say, a camera unit or a plurality of camera units in a camera system. Advantageously, this enables, in the case of continuous streaming of data images, real-time interpretation of movements within a scene.

It is envisaged that, for security, surveillance or military purposes, some of the images may be stored for review later. That is, it is envisaged that a system may be employed for military applications and automated to interpret a particular object as being a type of, say, weapon or moving vehicle. Before countermeasures are taken based on the automatically interpreted data, an Operator may be required to re-check the image data to ensure that a correct interpretation/match of the stored data with, say, the library of weapons/vehicles has been made.

It is envisaged that a sanity check of proposed objects incorporated from a library of objects may also be performed. For example, if an object has been assumed to resemble a rocket launcher and moves of its own accord, the system is configured to flag that the original interpretation may be incorrect and a manual assessment is then required.

In an enhanced embodiment of the present inventor, where multiple camera units are used, it is envisaged that a polling operation for retrieving 2D images from subsequent cameras may be employed to intermittently update parts of the 3D model of the scene.

In a yet further enhanced embodiment of the present invention it is envisaged that automatic detection of changes in bit/pixel values of a 2D image may be made, to ascertain whether a 3D model needs to be updated. In this context, an image encoder may only transmit bit/pixel values relating to the change. Alternatively the image encoder may not need to transmit any new ‘differential’ information if a change, determined between a currently viewed image frame and a stored frame, is below a predetermined threshold. A faster multiplexing mode of such image data can be achieved by the encoder sending an end marker to the decoder without any preceding data. In this regard, the receiving end treats this case as if it had signalled that camera to stop transmitting and had subsequently received an acknowledgement. The receiving end can then signal to the next camera in the polling list to start encoding and transmitting.

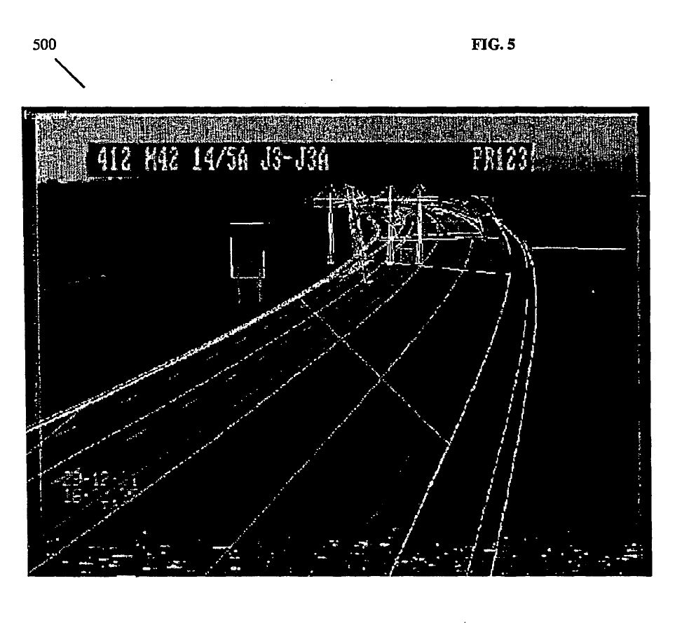

It is envisaged that the inventive concepts described herein can be advantageously utilised in a wide range of applications. For example, it is envisaged that suitable applications may include one or more of the following:
(i) Training/Briefing—Training of incident response teams, carried out in a safe environment, for various scenarios including, say, fire or terrorist attack.
(ii) Prevention—Awareness of high tech security systems, e.g. employing the inventive concept described herein may be used to help prevent terrorist attack. In addition, various potential scenarios can be tested using the real-time model to determine whether additional security measures are required.
(iii) Detection—Incidents can be detected before or as they happen, for example, a truck moving into a restricted area. The position of the truck can then be detected in 3D space and its movements monitored from any angle.
(iv) Investigation—If an incident has occurred, it can be reconstructed in 3D using the available technology from this invention. An example of such a reconstruction is illustrated in the road transport photograph of FIG. 5. The incident can then be viewed from any angle to identify what happened.
(v) Real-time applications, such as use by the emergency services in, say, directing fire fighters through smoke filled environments using updated models, assuming that 2D data can be readily obtained.

It is envisaged that the proposed technique is also applicable to both wired and wireless connections/links between the one or more camera units that provide 2D data and a computer terminal performing the 3D computer modelling function. A wireless connection allows the particular benefit of updating a 3D computer model remotely.

It will, be understood that the adaptive three-dimensional (3D) image modelling system, a processing unit capable of generating and updating a 3D image and a method of updating a 3D computer model representation, as described above, aim to provide one or more of the following advantages:
(i) There is no need for additional 3D surveys or scans to be performed to update a 3D computer model;
(ii) Thus, the proposed technique for updating a 3D computer model is significantly less expensive than known techniques;
(iii) The proposed technique is safer, as the 3D computer model can be updated remotely, i.e. away from dangerous locations where surveillance may be required; and
(iv) The proposed technique is substantially quicker in updating a 3D computer model, in that the 3D computer model can be updated in a matter of minutes rather than days.

Whilst the specific and preferred implementations of the embodiments of the present invention are described above, it is clear that one skilled in the art could readily apply variations and modifications that would still employ the aforementioned inventive concepts.

Thus, an adaptive three-dimensional (3D) image modelling system, a processing unit capable of generating and updating a 3D image and a method of updating a 3D computer model representation have been provided wherein the abovementioned disadvantages with prior art arrangements have been substantially alleviated.

1. An adaptive three-dimensional (3D) image modelling system comprising:
a 3D computer modelling function having an input that receives 3D data and generates a 3D computer model from the received 3D data; wherein the adaptive three-dimensional (3D) image modelling system is characterised by:
a two-dimensional (2D) input providing 2D data such that the 3D computer modelling function updates the 3D model using the 2D data.

2. The adaptive three-dimensional (3D) image modeling system according to claim 1, further characterised in that the 3D computer modelling function comprises a virtual camera function which is configured to substantially replicate in 3D space a location of a 2D data capture unit in a real environment providing the 2D data.

3. The adaptive three-dimensional (3D) image modelling system according to claim 1, further characterised in that the 3D computer modelling function translates the received 2D data into two dimensions of the 3D model.

4. The adaptive three-dimensional (3D) image modelling system according to claim 1, further characterised in that 3D computer modelling function performs a matching operation from commensurate perspective views between the 3D model and the 2D image data.

5. The adaptive three-dimensional (3D) image modelling system according to claim 1, further characterised in that one or more camera units are operably coupled to the adaptive three-dimensional (3D) image modelling system to provide 2D image data.

6. The adaptive three-dimensional (3D) image modelling system according to claim 5, further characterised in that one or more photographic image(s) from the one or more camera units is updated manually or automatically if a change in the environment is detected.

7. The adaptive three-dimensional (3D) image modelling system according to claim 1, further characterised in that updating of the 3D computer model is performed continuously or intermittently using the 2D image data.

8. The adaptive three-dimensional (3D) image modelling system according to claim 1, further characterised in that the 3D computer model is updated using one or more objects from a library of objects.

9. A signal processing unit capable of generating and updating a three dimensional (3D) model from 3D data; wherein the signal processing unit is characterised in that it is configured to receive two-dimensional (2D) data such that the 3D model is updated using the 2D data.

10. A method of updating a three dimensional (3D) computer model characterised by the steps of:
receiving two dimensional (2D) data; and
updating the 3D computer model using the 2D data.

11. The method of updating a three dimensional (3D) computer model according to claim 10 further characterised by the step of:
substantially replicating in 3D space a location of a 2D data capture unit in a real environment in order to provide the 2D data.

12. The method of updating a three dimensional (3D) computer model according to claim 10, further characterised by the step of:
translating the received 2D data into two dimensions of the 3D model.

13. The method of updating a three dimensional (3D) computer model according to claim 10 further characterised by the step of:
performing a matching operation from similar perspective views between the 3D model and the 2D image data.

14. The method of updating a three dimensional (3D) computer model according to claim 10 further characterised by the steps of:
detecting a change in a scene represented by the 2D data; and updating the 3D model manually or automatically in response to the detection of a change in the scene.

15. The method of updating a three dimensional 3D computer model according to claim 14 further characterised in that the step of updating is performed using one or more objects from a library of objects.
